(19) United States
(12) Patent Application Publication
(10) Pub. No.: US 2004/0239804 A1
(43) Pub. Date: Dec. 2, 2004

(54) System and method for editing the cyber teaching data having multi-layer and recording medium

(76) Inventor: Daechul Jo, Seoul (KR)

Correspondence Address: JONES DAY, 222 EAST 41ST ST, NEW YORK, NY, 10017, US

(21) Appl. No.: 10/491,940

(22) PCT Filed: Oct. 5, 2002
(86) PCT No.: PCT/KR02/01855

(30) Foreign Application Priority Data
Oct. 6, 2001 (KR) 2001-61585

(51) Int. Cl. H04N 5/04

(52) U.S. Cl. 348/500

(57) ABSTRACT

The present invention provides a multi-layered electronic lecturing system, a method and a storage medium to link a multi-layer of an existing electronic lecture content with an additional real-time drawing and sound recording by a lecturer or a trainee, simultaneously reproducing the existing lecture content so that newly added drawings, or sounds can be reproduced synchronously with the existing lecture data.

### TECHNICAL FIELD

The present invention relates to a multi-layered electronic lecturing method and system, and more particularly, to the multi-layered electronic lecturing tool, the method, and the storage medium having a real-time drawing and sound recording capability on playing a pre-produced electronic lecture content, capable of synchronously reproducing an existing electronic lecture content and newly added recording.

### BACKGROUND ART

Recently, real time information providing services have been actively developed with the development of information and communication technology. The services provide a variety of data for a plurality of subscribers by using at least one host server in real time via data communication networks.

In particular, technologies such as cache memory extensions, information retrievals, and data compressions have been developed in order to provide subscribers with higher data rates in addition to satisfy subscribers' preferences and needs. Further, with the help of these technologies, lots of digital contents and solutions are under active development.

As one of such development, lecture-related or conference-related contents and solutions for use in remote lecture or tele-conference have been widely developed. Electronic publishing business became popular with the advent of so-called a cyber-university.

As for the tele-conference system, by nature, transmission and reproduction of data should be performed in real time. As for the remote lecture, however, it is not always necessary to perform a real time data transmission and reproduction.

Prior developments for the cyber-university or the remote lecture have aimed mainly at production and transmission of a lecture data comprising, for the most part, text, images, and moving picture contents. Therefore, methods for an efficient reproducing and recording for the lecture data have not been sufficiently developed.

In such a prior art, once-produced data or content may only be reproduced, as a result, it does not provide the method to record newly added drawings, or sounds, simultaneously reproducing an existing lecture data so that newly added drawings, or sounds can be reproduced synchronously with the existing lecture data.

U.S. Pat. No. 5,583,980 discloses a method for recording newly added voice or electronically written content to an existing audiovisual data by using a recording device, such as a camcorder, for synchronizing and combining the existing audiovisual data and newly added content to be recorded, and for reproducing a combined audiovisual data.

U.S. Pat. No. 5,838,313 discloses a method for adding a new data annexed during reproducing an existing data by using a white-board function and a reporting function.

In addition, U.S. Pat. No. 6,226,785 also discloses a method capable of not only recording newly annexed data during reproducing an existing data, but also distinguishing data annexed by a plurality of different users.

These methods, however, have limitations in that new content cannot be annexed during repetitive reproduction of the original lecture data since an annexing function of newly annexed data may be done only once.

### DISCLOSURE OF INVENTION

The present invention provides a multi-layered electronic lecturing system, a method and a storage medium enable of linking a multi-layer of an existing multimedia data for an electronic lecture with an additional content recorded by a lecturer or a trainee, and for repeatedly storing and reproducing a linked data.

According to an aspect of the present invention, there is provided a multi-layered electronic lecturing system comprising: a first reproducing means for reproducing an existing lecture content stored at a terminal of a lecturer or a trainee and used for an electronic lecture; an input means for inputting a signal selected by the lecturer or the trainee; a layer management means for directing different layers to a reproducing and a recording operation respectively; a recording means for recording annexed data along with time stamp on a layer of the existing lecture content for the electronic lecture designated by the layer management means; an attribute storing means, inter-working with the recording means, for storing an annexed data and attributes on a layer of the existing lecture content for the electronic lecture designated by the layer management means; a synchronizing means for synchronizing the existing lecture content for the electronic lecture to the annexed data added by means of the recording means and the attribute storing means; and a second reproducing means for selectively reproducing the annexed data added to the existing lecture content by the time and the layer.

According to the other aspect of the present invention, there is provided a multi-layered electronic lecture method capable of recording annexed data on different layers classified by a recording time during a reproduction of an existing lecture content for an electronic lecture and selectively reproducing data stored in respective layer by using a system for reproducing the existing lecture content for the electronic lecture stored at a terminal of a lecturer or a trainee.

### BRIEF DESCRIPTION OF DRAWINGS

The above and other objects and features of the present invention will become apparent from the following description of a preferred embodiment given in conjunction with the accompanying drawings, in which:

FIG. 1 schematically illustrates a structure of a multi-layered electronic lecturing tool including an audiovisual edit section in accordance with a preferred embodiment of the present invention;

FIG. 2 is a diagram for explaining the inventive multi-layered electronic lecturing tool including an audiovisual edit section;

FIG. 3 schematically illustrates a procedure for drawing an elliptical figure shown in FIG. 2;

FIG. 4 shows a recording state between the layers in the multi-layered electronic lecturing tool in accordance with a preferred embodiment of the present invention;

FIG. 5 is a multi-layered logical scheme for use in the multi-layered electronic lecturing tool including an audiovisual edit section in accordance with a preferred embodiment of the present invention;

FIG. 6 is a flow chart illustrating a signal flow of the multi-layered electronic lecturing tool in accordance with a preferred embodiment of the present invention;

FIG. 7 shows a merger process in the multi-layered electronic lecturing tool in accordance with a preferred embodiment of the present invention; and

FIG. 8a and FIG. 8b show a time length of each layer recorded by using the multi-layered electronic lecturing tool in accordance with a preferred embodiment of the present invention.

### BEST MODE FOR CARRYING OUT THE INVENTION

Hereinafter, a preferred embodiment of the present invention will be described in detail with reference to the accompanying drawings.

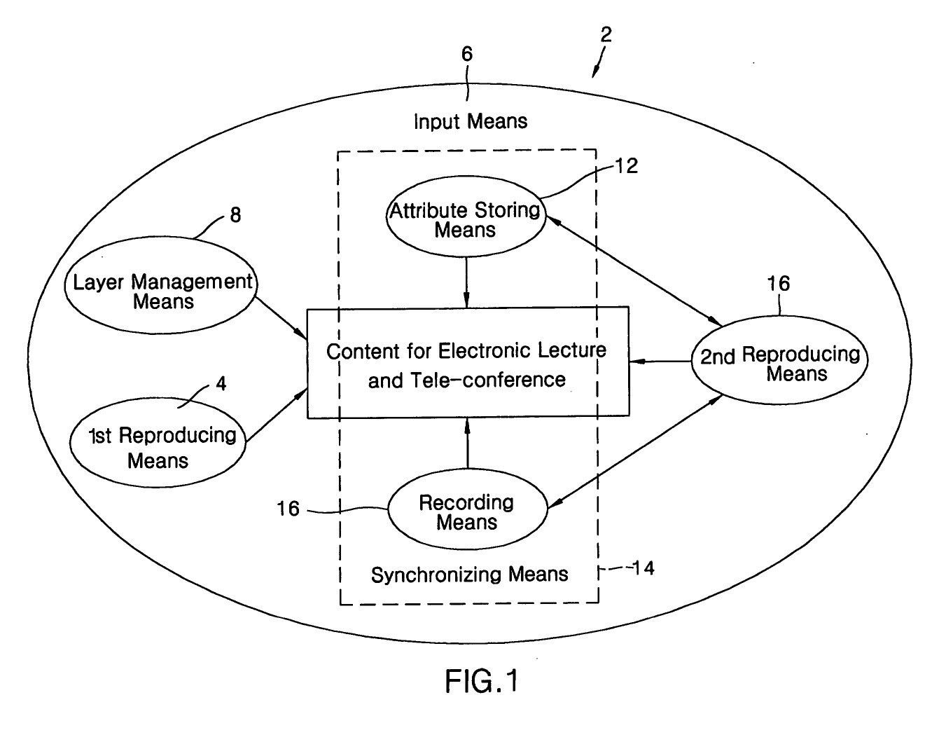

FIG. 1 schematically illustrates a structure of a multi-layered electronic lecturing tool including an audiovisual edit section in accordance with a preferred embodiment of the present invention.

Referring to FIG. 1, the inventive multi-layered electronic lecturing tool including the audiovisual edit section comprises a first reproducing means 4 for reproducing an existing lecture content used for an electronic lecture and tele-conference, an input means 6 for inputting an input signal selected by a lecturer or a trainee, a layer management means 8 for directing different layers to a reproducing, a recording and a transcribing operations, respectively, for the existing lecture content, a recording means 10 for recording an annexed data along with time stamp on a layer of the existing lecture content for the electronic lecture and tele-conference designated by the layer management means 8, an attribute storing means 12, inter-working with the recording means 10, for storing an annexed data based on time on a layer of the existing lecture content for the electronic lecture and tele-conference designated by the layer management means 8; a synchronizing means 14 for synchronizing the existing lecture content for the electronic lecture and tele-conference and the annexed data added by means of the recording means 10 and the attribute storing means 12; a second reproducing means 16 for selectively reproducing the annexed data added to the existing lecture content by the time and the layer.

The first reproducing means 4 includes algorithms for reproducing files in various formats, such as BMP, JPG, GIF, WMF, EMF, ICO and the like, and a monitor driving unit inter-working with the algorithms. The first reproducing means 4 may be a conventional means for reproducing multimedia data.

The input means 6 is used for enabling the lecturer or the trainee to input the annexed data that he or she want to add on by recording or editing an audiovisual content through various layers of an electronic lecture data. The input means 6 may include a mouse, a pen mouse, a touch-screen, a keyboard, a graphic tablet and a joy-stick, and the like.

The layer management means 8 is used for directing or designating the annexed data to a specific layer of the existing lecture content when the lecturer or the trainee records the annexed data. The data stored in each layer can be reproduced based on each respective layer, each recorder, and each input time.

The recording means 10 enables the lecturer or the trainee to record the annexed data on each different layer. In particular, the lecturer or the trainee may record the annexed data by inputting the annexed data consisting of a text, a graphic animation and a moving image by using the input means 6 such as the mouse and the keyboard, or by using various multimedia objects. Furthermore, the recording means 10 enables a plurality of the lecturer or the trainee to record the annexed data on the same layer for a specific electronic lecture data by using different recording means 10. On the contrary, the recording means 10 also enables a plurality of the trainees to record the annexed data on different layers, and to separately extract and reproduce the extracted content.

The attribute storing means 12 performs, like the recording means 10, recording of the annexed data, particularly, recording of various events occurred during creation of the annexed data and the occurring time of the events in combination, etc. through inter-working with the recording means 10. The attribute storing means 12 also records historical particulars occurred during the use of the annexed data or the existing lecture content such as a creation, a deletion, a movement, a size or a color, a change of attributes of an object. The attribute storing means 12 also stores specific data that can be separately extracted apart from a reproduction of the recording means 10.

The synchronizing means 14 performs synchronization of the annexed data inputted through the recording means 10 and the attribute storing means 12 with the existing lecture content. That is, the synchronizing means 14 is for synchronizing the time of the existing lecture content and the annexed data. The synchronizing means 14 synchronizes the annexed data with the existing lecture content by separately measuring and recording the time of the annex on the basis of a reproduction time of the existing lecture content.

The second reproducing means 16 converts, if necessary, files of various formats into a format compatible with output, and reproducing the annexed data annexed to different layers pursuant to a selection of the input means 6 in a synchronized manner. The second reproducing means 16, inter-working with the recording means 10 and the attribute storing means 12, records or attribute-stores the annexed data during the reproduction. Therefore, recording, attribute-storing and reproducing processes can be repeatedly performed as many times as a user wants since the recording operation and transcribing operation are linked with the reproduction.

Furthermore, the inter-operability of the recording means 10, the attribute storing means 12 and the second reproducing means 16 enables themselves to display or reproduce a designated portion of the existing lecture content, enables the user to review a portion of the annexed data added by the user, and further, enables the user to separately review the annexed data added by a third person.

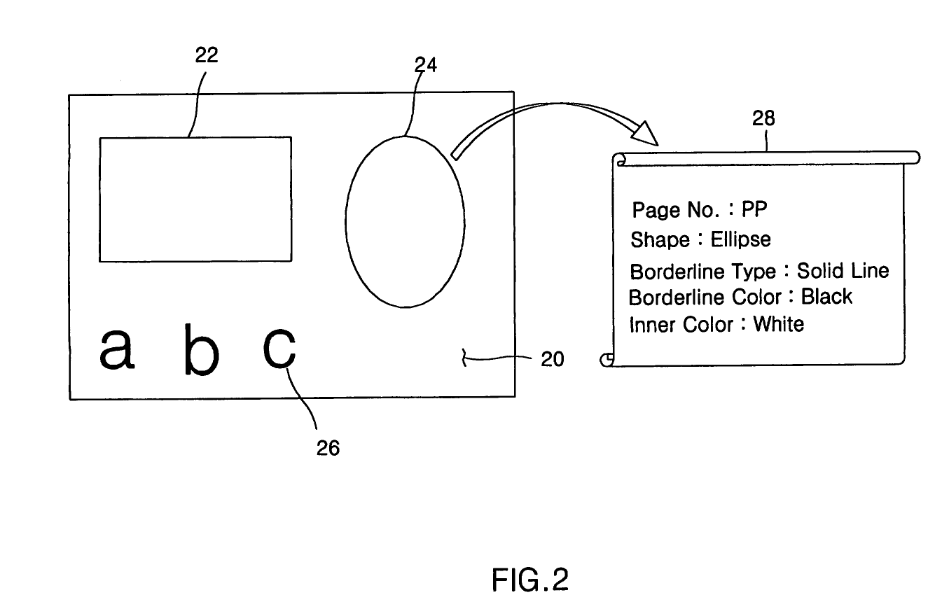

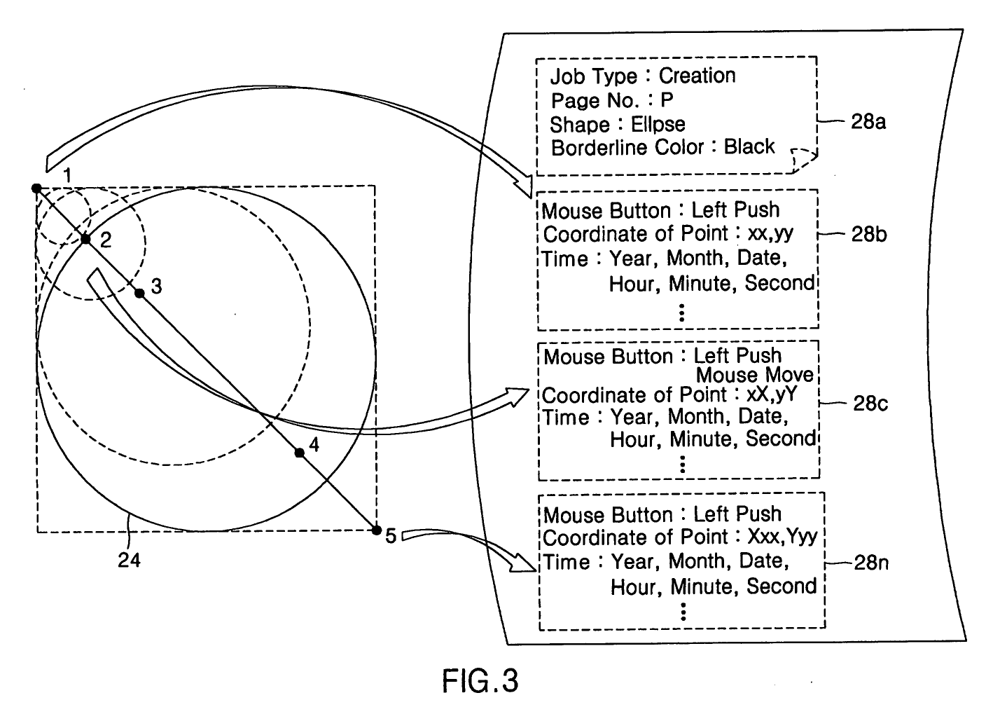

FIG. 2 is a diagram for explaining the inventive multi-layered electronic lecturing tool including an audiovisual edit section, and FIG. 3 schematically illustrates a procedure for drawing an elliptical figure shown in FIG. 2.

Referring to FIG. 2 and FIG. 3, while the existing lecture content is displayed on the screen of a terminal of the lecturer or the trainee, the lecturer or the trainee may draw and record the elliptical FIG. 24 and a character 26, etc. additionally on the existing lecture content through the recording means 10. The character 26 may be drawn and recorded free hand by means of a suitable input means such as a mouse.

Meanwhile, attributes 28 of the annexed data, i.e., the elliptical FIG. 24 and the character 26 can be recorded together with the annexed data by means of the attribute storing means 12, and the annexed data recorded can be simultaneously reproduced thereafter. The attributes 28 of the annexed data include, for example, a page number, an object shape type, a borderline type, a color of the borderline and a color of the object, etc.

The attributes 28 are designed to be recorded with time stamp, each presenting a storing time. Therefore, the stored data can be reproduced following the sequence of the storing. For example, as illustrated in FIG. 3, an elliptical figure may be drawn between two points 1 and 2 with time interval between a first position 1 when the mouse button was pressed and a second position 2 when the mouse cursor moved.

In addition, another elliptical figure would be drawn between two points 1 and 3 after a time interval in which the mouse cursor moves from the second position 2 to a third position 3. In other words, when this process is performed repeatedly to a fifth position 5, a whole procedure for generating the elliptical figure can be reproduced.

During these processes, each of the attributes (28a˜28n) is recorded on the basis of time by using the attribute storing means 12 so that the stored data can be reproduced on the basis of the recording time.

For example, if a recording order of the characters is ‘a’, ‘b’ and ‘c’, a reproduction order is the same with the recording order, i.e., ‘a’, ‘b’ and ‘c’, and a reproduction time interval between the characters is the same with the corresponding recording time interval.

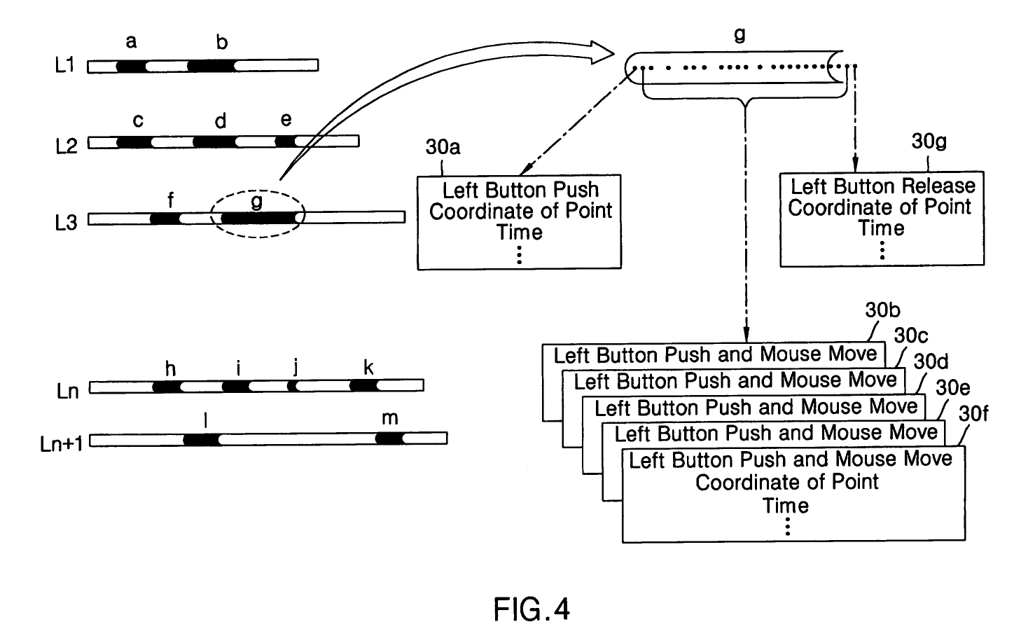

FIG. 4 shows a recording state between the layers in the multi-layered electronic lecturing tool in accordance with a preferred embodiment of the present invention.

Referring to FIG. 4, the annexed data added by the recording means 10 and the attribute storing means are stored in different layers L1˜LN+1 respectively for different users, e.g., the lecturer and the trainee. The attributes 30a˜30g of the annexed data are also stored along with the corresponding annexed data. The layers, in the preferred embodiment, imply logical spaces rather than physical spaces for storing the annexed data.

The annexed data may be one of both the auditory data and the visual data. As for the visual data, during reproduction thereof, a raster operation and a screen updating are performed as the same attributes and the same order as the annexed data has been created.

Furthermore, the visual data and the auditory data are stored in various storage means (e.g. a memory). Therefore, if a volume of the content or data to be stored is large, they may be stored in a higher-capacity storage means like a hard disk, and the annexed data of the visual data and the auditory data may also be stored in a separate auxiliary storage means (e.g. a file) for long-time keeping. The attribute-storing and the reproducing operation for the visual data and the auditory data are performed on separate threads. In addition, a reproduction, a pause, a rewind and a fast forward operation are available during reproduction of the annexed data.

In the multi-layered electronic lecturing tool including the audiovisual section in accordance with the present invention, a single layer (e.g., L1) is provided when an initial creating process starts, and created data is stored in the single layer. A reproduction process for the created data begins after the recording process ends.

As the user records new annexed data during the reproduction process, a new layer (e.g. L2) is created, and the new annexed data are stored in new layer. Thus, whenever the user records new content while the content is reproduced, as many new layers L2˜LN+1 as number proportional to the recording times are created respectively, and, thus, the annexed data can be stored regardless of the recording times.

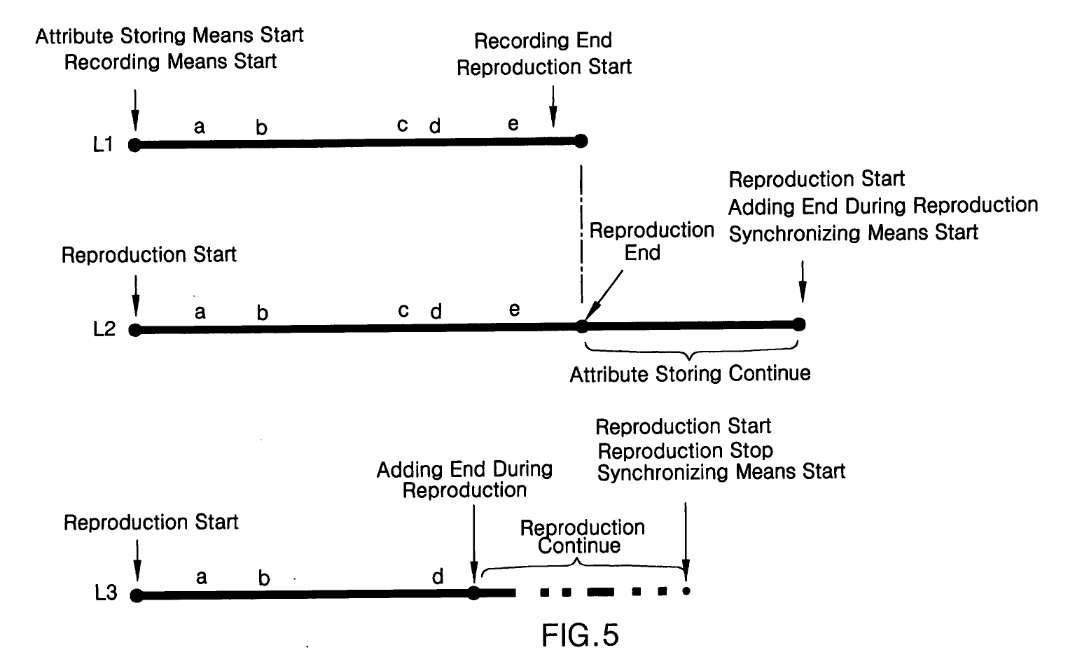

FIG. 5 is a multi-layered logical scheme for use in the multi-layered electronic lecturing tool including an audiovisual edit section in accordance with a preferred embodiment of the present invention.

Referring to FIG. 5, since the recording process for the annexed data will begin after a certain delay from the start of a system program of the electronic lecturing tool, the recording means 10 and the attribute storing means 12 start simultaneously with the start of the system program so that the delay may also be recorded.

When the user begins to record the annexed data by means of the recording means 10, layer 1 is automatically generated by the attribute storing means 12. Certain visual data such as “a, b, c, d and e” and the corresponding auditory data generated during the recording are stored in layer 1 at the same time.

Since an additional auditory data may be recorded after the recording of the visual data ends, the attribute storing means 12 operates continuously until the user finishes the operation of the attribute storing means 12.

Meanwhile, when the user generates an input signal using the 2nd reproducing means 16 to add a new annexed data during presenting an existing lecture data, a new layer 2 is created, and the new annexed data such as “1, 2 and 3” are recorded and stored on the new layer 2. The attribute storing means 12 operates in order to record the annexed data such as ‘4’ after a reproducing for layer 1 ends.

Thus, it is possible to record the electronic lecture data having at least two layers. When the electronic lecture data having more than two layers is reproduced, the synchronizing means 14 synchronizes content recorded on each layer on the basis of time order before the reproducing for the electronic lecture data.

For example, even if the content on layer 1 is recorded at a certain time in the year of 1995 and annexed data is annexed to the electronic lecture data and recorded on layer 2 at a certain time in the year of 2000, content of layer 1 and layer 2 can be simultaneously reproduced thereafter. Of course, content of each layer may be respectively reproduced.

When the user operates the first or the second reproducing means after recording the annexed data on layer 2, the corresponding annexed data is reproduced. During the reproducing process, when the user wants to add another annexed data, a new layer 3 is created. The user can record another annexed data on new layer 3. The reproducing process for the remaining content continues, though the recording of another annexed data finishes, if there remains any content to be reproduced in one of layer 1 and layer 2. That is, the reproducing process continues until a stop command is inputted or the reproduction process is done with respect to the longest layer.

Meanwhile, once the recording on layer 3 is done, and if the user selects again the reproduction process while the content in layer 1 and layer 2 are replayed, the content including all the data in the layer 1, 2 and 3 will be reproduced again.

These recording and reproducing operations may be performed as many times as the user wants. Of course, it is not necessary to create a new layer in case that no new annexed data are recorded during the reproduction process.

Any kind of annexed data, e.g., an auditory data or a visual data or both can cause creation of a new layer when newly added.

Thus, the content in different layers are superposed and recorded on the original data and all content related are presented simultaneously by using the successive processes as described above. Furthermore, information on the whole process, such as audiovisual content, various events, and occurring time of the events, etc. will be stored on each corresponding layer so that the whole content can be reproduced at the same time relative to the recording process.

Certainly, the inventive multi-layered electronic lecturing tool is capable of separately reproducing the recorded content. For example, content recorded by different users can be stored on different layers, and can be presented independently.

In addition, since the audiovisual data recorded by different user are stored on different layers separately, all or part of the data recorded by the different users can be presented selectively.

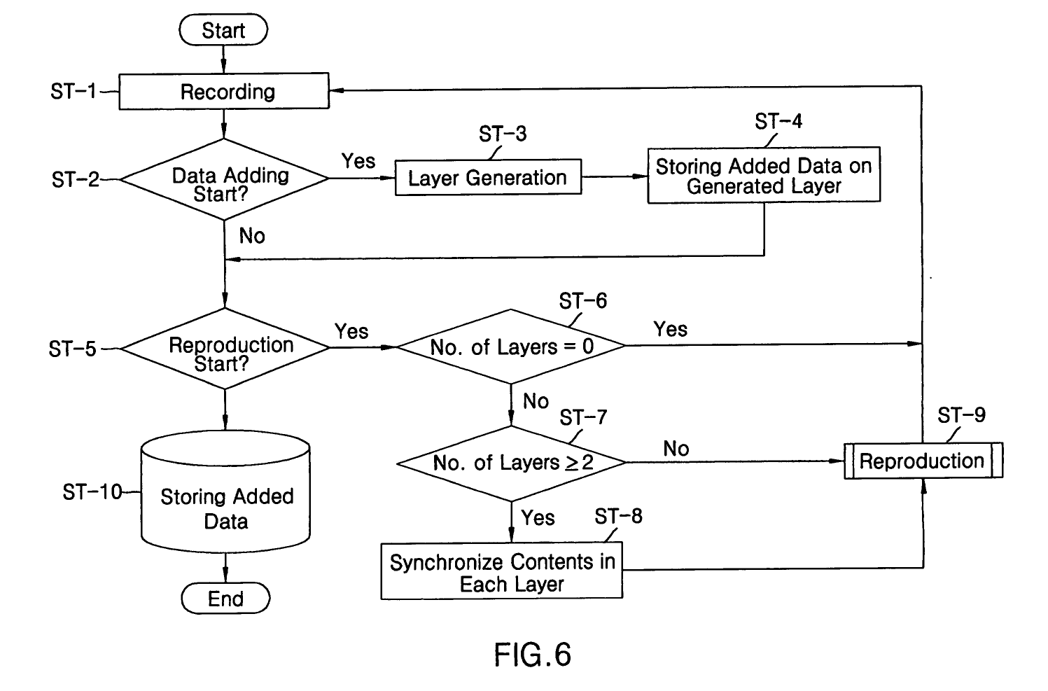

FIG. 6 is a flow chart illustrating a signal flow of the multi-layered electronic lecturing tool in accordance with a preferred embodiment of the present invention.

Attributes are stored with respect to the electronic lecture data (the first step; ST-1), and it is determined whether annexed data are added or not by operating the recording means 10 and the attribute storing means 12 (the second step; ST-2).

When annexed data is determined to be added, a new layer is created (the third step; ST-3) and the annexed data is stored on the created layer (the fourth step; ST-4).

When the user reproduces the corresponding data after adding the content (the fifth step; ST-5), the number of the created layer is checked. If the number of the created layers is determined to be “0”, the reproduction process is not performed because there is no data recorded.

Subsequently, it is checked whether the number of the created layer is more than or equal to two (the seventh step; ST-7). If the number of the created layers is ‘1’, the corresponding data is immediately reproduced without a synchronization process (the ninth step; ST-9), and if the number of the layers is more than or equal to two, the corresponding data is reproduced after performing the synchronization process (the eighth step; ST-8).

If the user enters an input signal for storing data without no more reproducing operation, the corresponding data is stored (the tenth step; ST-10).

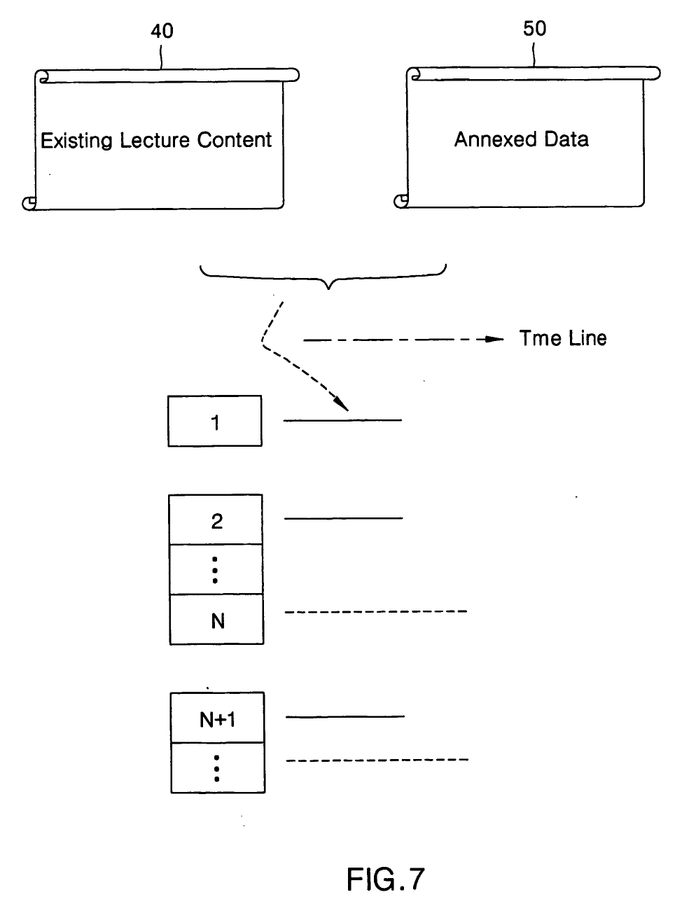

FIG. 7 shows a merger process in the multi-layered electronic lecturing tool in accordance with a preferred embodiment of the present invention.

Referring to FIG. 7, since the lecturer gives a lecture with an existing lecture content 40 stored on a single layer, the single layer stores the electronic pre-recorded lecture data 40.

The N−1 number of layers from layer 2 to layer N store annexed data annexed during repetitive reproduction operations during the lecture. That is, the number N−1 means the number of times repeating the reproduction operations.

Therefore, in case there is only one lecturer, the number N−1 is the number of times the lecturer has repeated the reproduction operation, and in case there are more than or equal to two lecturers, the number N is the number determined by both factors of the number of the lecturer and the repeating times of the reproduction operation.

The layers given a number of more than N+1 store the content that trainees record during the lecture. An electronic lecture content 50 stored on the single layer may include a plurality of layers and a plurality of pages if the electronic lecture content 50 is recorded by using the recording means 10 and the attribute storing means 12 in accordance with the present invention.

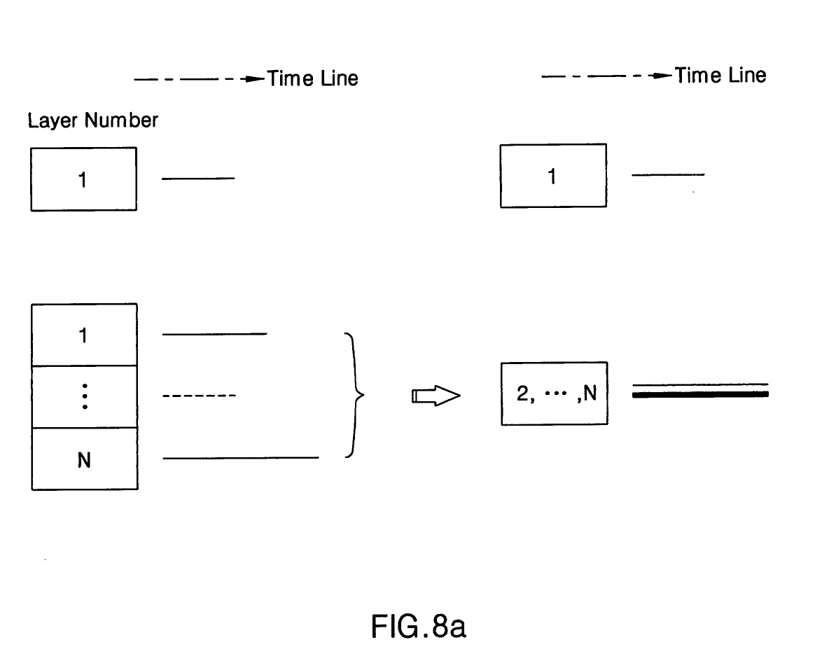

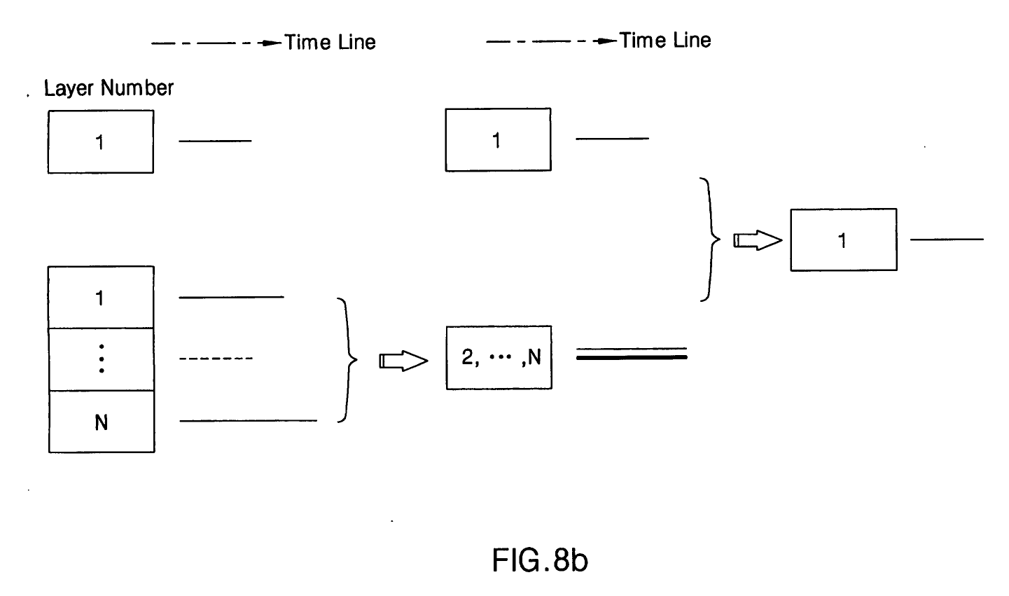

FIG. 8a and FIG. 8b show a time length of each layer recorded by using the multi-layered electronic lecturing tool in accordance with a preferred embodiment of the present invention.

Referring to FIG. 8a and FIG. 8b, the initial electronic lecture content first prepared by an initial data recorder is stored on the layer of the lowest level, and the layers from 2 to N recorded by the lecturer during the lecture are combined to the initial electronic lecture data.

Then, trainees may record annexed data on the layer numbered equal to or more than N+1 during lecture.

In addition, as shown in FIG. 8b, the layers recorded by the lecturer may be merged into one object, and, subsequently, the merged object may be combined again with data recorded on the layer recorded by the initial data recorder so that trainees may utilize the final merged data.

In accordance with the multi-layered electronic lecturing tool and method of the present invention, the initial data recorder, the lecturer and the trainee can add or record the annexed data to the initial electronic lecture data prepared. The recording time may also be stored so that the annexed data can be reproduced pursuant to the sequence and interval of the recording.

In addition, various annexed data can be repeatedly recorded during reproduction of the electronic lecture data as many times as desire. It is possible to sever or merge the annexed data added not only by a single user but also by different users.

The amount of the annexed data is generally much less than the initial electronic lecture content so that the consumption of system resource can be reduced. In addition, multimedia objects of various formats may be used, and thus, no additional install hardware is required.

While the embodiments illustrated in the figures and described above are presently preferred, it should be understood that these embodiments are offered by way of example only. The invention is not limited to a particular embodiment, but extends to various modifications, combinations, and permutations that nevertheless fall within the scope and spirit of the appended claims.

What is claimed is:

1. A multi-layered electronic lecturing system comprising:
a first reproducing means for reproducing an existing lecture content stored at a terminal of a lecturer or a trainee and used for an electronic lecture;
an input means for inputting a signal selected by the lecturer or the trainee;
a layer management means for directing different layers to a reproducing and a recording operation respectively;
a recording means for recording annexed data along with time stamp on a layer of the existing lecture content for the electronic lecture designated by the layer management means;
an attribute storing means, inter-working with the recording means, for storing an annexed data and attributes on a layer of the existing lecture content for the electronic lecture designated by the layer management means;
a synchronizing means for synchronizing the existing lecture content for the electronic lecture to the annexed data added by means of the recording means and the attribute storing means; and
a second reproducing means for selectively reproducing the annexed data added to the existing lecture content by the time and the layer.

2. The system as claimed in claim 1, wherein the recording means can selectively record the annexed data on a same layer or on a different layer to the selection of a recorder.

3. The system as claimed in claim 1, wherein the attribute storing means stores various attributes including various events occurred during the recording operation, an occurring time of the events, an operation feature and operation details.

4. A multi-layered electronic lecture method capable of recording annexed data on different layers classified by a recording time during a reproduction of an existing lecture content for an electronic lecture and selectively reproducing data stored in respective layer by using a system for reproducing the existing lecture content for the electronic lecture stored at a terminal of a lecturer or a trainee.

5. The method as claimed in claim 4, the method for recording annexed data on a plurality of layers and the method for reproducing a required data comprising the steps of:
(a) storing the annexed data along with time stamp during reproduction of the existing lecture content for the electronic lecture;
(b) determining whether the annexed data is added;
(c) generating a new layer pursuant to an addition of the annexed data;
(d) storing the annexed data on a corresponding layer;
(e) reproducing the corresponding contents after the addition of the annexed data ends;
(f) counting the number of the layers;
(g) reproducing the annexed data; and
(h) storing the corresponding contents to an input signal confirming the storing when there are no content to be reproduced.

6. The method as claimed in claim 5, wherein the step (e) is not performed when the number of the layers is “0”.

7. The method as claimed in claim 5, wherein the corresponding contents is immediately reproduced without a synchronization process, when the number of the layers is less than “2”.

8. The method as claimed in claim 5, wherein when the number of the layer is more than or equal two, further comprises the steps of:
(i) synchronizing the respective layer; and
(j) reproducing the corresponding data after synchronizing the layer.

9. The method as claimed in claim 5, wherein the annexed data can be selectively stored on a same layer or different layers in accordance with a recorder's choice.

10. The method as claimed in claim 5, wherein the annexed data stored on a plurality of the layer of the existing lecture content can be selectively reproduced, merged and deleted by the time and the layer.

11. The method as claimed in claim 5, wherein the annexed data stored on a plurality of layer of the existing lecture content include the annexed data, an addition time of the annexed data, and attributes of the annexed data.

12. The method as claimed in claim 5, wherein the annexed data stored on the plurality of layer of the existing lecture content are reproduced pursuant to the sequence of recording time and attribute storing time.

13. A storage medium storing electronic lecture content for use in a multi-layered electronic lecture method capable of recording annexed data on different layers by a recording time during a reproduction of an existing lecture content for an electronic lecture and selectively reproducing a data of a respective layer during a reproduction process by using a system for reproducing the existing lecture content for the electronic lecture stored at a terminal of a lecturer or a trainee.
